(19) United States
(12) Patent Application Publication
(10) Pub. No.: US 2014/0281987 A1
(43) Pub. Date: Sep. 18, 2014

(54) PROVIDING A UNIVERSAL RESOURCE MANAGER TO ACCESS AND DISPLAY USER CUSTOMIZABLE CONTENT, TO SWITCH CONTENT ON DEMAND, AND TO OPTIMIZE THE USER ENVIRONMENT

(71) Applicants: Jason A. Sullivan, Salt Lake City, UT (US); Caleb A. Bartholomew, Salt Lake City, UT (US)

(72) Inventors: Jason A. Sullivan, Salt Lake City, UT (US); Caleb A. Bartholomew, Salt Lake City, UT (US)

(21) Appl. No.: 14/199,996

(22) Filed: Mar. 6, 2014

Related U.S. Application Data
(60) Provisional application No. 61/774,573, filed on Mar. 7, 2013.
(60) Provisional application No. 61/912,546, filed on Dec. 5, 2013.

(51) Int. Cl. G06F 3/0482

(52) U.S. Cl. CPC G06F 3/0482
USPC 715/716

(57) ABSTRACT

The present invention relates to providing a single console to access and display or otherwise output user customizable content from a plurality of content sources. In particular, the present invention relates to channeling content from a variety of content sources to the television so as to provide a collection of all digital content that is important to the user and available on a single console, wherein the content may come from competing providers and is customizable by the user. Further, the system dynamically alerts and provides information to the user, wherein the alerts and information is customizable by the user.

### RELATED APPLICATIONS

This application claims priority to U.S. Provisional Patent Application Ser. No. 61/774,573 (Attorney Docket Number: 11072.532) filed Mar. 7, 2013, entitled “PROVIDING A SINGLE CONSOLE TO ACCESS AND DISPLAY USER CUSTOMIZABLE CONTENT FROM A PLURALITY OF CONTENT SOURCES” and claims priority to U.S. Provisional Patent Application Ser. No. 61/912,546 (Attorney Docket Number: 11072.633) filed Dec. 5, 2013, entitled “PROVIDING A UNIVERSAL RESOURCE MANAGER TO SWITCH CONTENT FROM VARIOUS SOURCES ON DEMAND AND TO OPTIMIZE THE USER ENVIRONMENT,” which are all expressly incorporated herein by reference in their entireties.

### BACKGROUND

1. Field of the Invention

The present invention relates to providing a single console to access and display or otherwise output user customizable content from a plurality of content sources. In particular, the present invention relates to channeling content from a variety of content sources so as to provide a collection of all content that is important to the user and available on a single console, wherein the content may come from competing providers and is customizable by the user. Further, a universal resource manager is provided to selectively switch between the content on demand and to optimize the user environment. Moreover, the system dynamically alerts and provides information to the user, wherein the alerts and information is customizable by the user.

2. Background

As one of the most influential technologies in either the modern or historical world, computers and computer systems have significantly altered the way we conduct and live our lives, and have accelerated technological advancement to an exponential growth pace. Indeed, computers and computing systems play an indispensable role in driving invention, enabling lightning speed technological advancement, simplifying tasks, recording and storing data, connecting the world, as well as numerous other applications in virtually every industry and every country around the world. Indeed, the computer has become an indispensable tool for individuals, businesses, and governments alike. Since its inception, the computer and computing systems have undergone significant evolutionary changes. The small, powerful modern systems in use today are virtually incomparable to their ancestral counterparts of yesteryear.

Although the evolution of the processing capabilities of computers and computing systems reveals an exponential growth pattern, the physical and structural characteristics of these systems, namely the cases or encasement modules housing such electrical components as the processing (printed circuit boards, mother boards, etc.) and the peripheral components (hard drives, CD/DVD-ROM drives, sound cards, video cards, etc.) has unfortunately been limited to marginal improvement, with design considerations dictated by needed functionality, workability, and various component inclusion and associated design constraints. Computers and computing systems of today have not been able to shed the large, bulky encasement modules that support the processing and other components.

Conventional computer systems and their encasement modules, namely desktops, servers, and other similar computers or computing systems, while very functional and very useful, are large and bulky due to several reasons, one being that they are designed to comprise all of the components and peripheral devices necessary to operate the computer system, except the various external devices such as a monitor, a keyboard, a mouse, and the like. Indeed, partly to blame for the proliferation and slow evolution of the large and bulky computer encasement module is the perceived convenience of bundling both processing components and peripheral components within a neat, easy-to-use, single package. Such encasement modules have a rather large footprint, are heavy, and do not lend themselves to mobility or environmental adaptability. However, little has been done to move away from this and such systems are commonplace and accepted. For example, server systems are typically found within some type of area or space or room specifically designed to house the box-like structure; desktop computers occupy a significant amount of space of workstations, with their presence sometimes concealed within desks; or, some computers are left out in the open because there is nowhere else to place them.

While obviously there are a significant number of advantages and benefits, there are several problems or flaws, both inherent and created, associated with conventional computers and computing systems and the encasement modules comprising such. Accordingly, it would be an improvement in the art to augment or even replace current techniques with other techniques.

### SUMMARY

The present invention relates to providing a single console to access and display or otherwise output user customizable content from a plurality of content sources. In particular, the present invention relates to channeling content from a variety of content sources to the television so as to provide a collection of all digital content that is important to the user and available on a single console, wherein the content may come from competing providers and is customizable by the user. Further, a universal resource manager is provided to selectively switch between the content on demand and to optimize the user environment. Moreover, the system dynamically alerts and provides information to the user, wherein the alerts and information is customizable by the user.

In accordance with implementations of the present invention, a single console is able to access a variety of content sources, thereby providing a single hub at the console for establishes a marketplace of digital content that is important to the user. Such sources include programming, digital music, digital pictures, games, communications, control systems, monitors, movies, and other types of digital content or functions. A menu is provided to allow a user to provide input to determine the preferred source for the programming, digital music, digital pictures, games, communications, control systems, monitors, movies, and other types of digital content. Thus, a collection of content providers is accessible by a single console/device.

A universal resource manager is provided to selectively switch between the content on demand and to optimize the user environment. A collection of content types is provided and controllable by the user, such types include games, television, movies, music, computer format, etc. The user is able to select and/or associate one or more sources for each content type. Further, a user can create new content types and associate one or more content providers with the new content types. Each content type is a resource. The universal resource manager allows the user to virtually plug in a desired resource when wanted and unplug the resource when no longer wanted. Thus, for example, the universal resource manager allows a user to select the resource “games” and then the video games from the established game content source are available for play by for the user. Moreover, the experience is optimized by the universal resource manager by unplugging or otherwise not engaging any of the other content types to allow for optimal use of processing power and system settings for the desired resource, namely the video games. Once the user no longer desires to play the video games, the universal resource manager allows the user to virtually unplug the games resource on demand and virtually plug in another resource, such as “movies,” to allow the user to select a movie available from the movie content source/provider and thus watch the movie. The universal resource manager causes all processing power and settings to be optimized and available for the resource in use by virtually unplugging or otherwise disengaging all other resources.

In some implementations, the user can virtually plug in multiple resources at the same time. For example, the user can listen to music from the music resource while at the same time surfing on the internet through the computer resource. However, when the computer resource is no longer desired and the user wants to experience a different resource, the browser is virtually unplugged such that it is completely turned off and is not consuming processing power to allow the processing power and settings to be used for the new resource that is desired by the user. Further, the user can virtually unplug the music resource or keep it playing while experiencing the new resource.

Thus, in accordance with at least some implementations, the universal resource manager selectively launches or otherwise makes available content that is desired by the user and turns it off on demand, wherein the available content to the user comes from a variety of sources and across a variety of platforms.

The collection of content providers is controllable by the user to provide the content sources and content that is desired by the user. The user determines the collection or array of content providers, which can include competing content providers and/or content providers that use different platforms. The various sources are masked or otherwise categorized through a single menu system to assist the user to navigate to the particular type of content that is desired, such as games, programming, music, monitoring systems, etc. The collection of all digital content that is important to the user converges and is made available at a single console. In some implementations, content sources are physical (i.e. home automation) to allow a user to monitor or otherwise control a function.

These and other features and advantages of the present invention will be set forth or will become more fully apparent in the description that follows. The features and advantages may be realized and obtained by means of the instruments and combinations provided herein. Furthermore, the features and advantages of the invention may be learned by the practice of the invention or will be obvious from the description, as set forth hereinafter.

### BRIEF DESCRIPTION OF THE DRAWINGS

In order to set forth the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a block diagram that provides a representative console labeled as a modular processing unit that is connected to peripherals to provide a representative computing enterprise in accordance with the present invention;

FIG. 2 illustrates a representative embodiment of a durable and dynamically modular processing unit or console;

FIG. 3A illustrates another view of the embodiment of FIG. 2 having a non-peripheral based encasement, a cooling process (e.g., thermodynamic convection cooling, forced air, and/or liquid cooling), an optimized layered printed circuit board configuration, optimized processing and memory ratios, and a dynamic back plane that provides increased flexibility and support to peripherals and applications;

FIGS. 3B-3C illustrate other representative embodiments;

FIG. 4 illustrates another representation of a console or device that can be used in association with embodiments of the present invention;

FIG. 5 illustrates a representative networked system that can be used in association with embodiments of the present invention;

FIG. 6 illustrates a representative console connected to a television and controlled by a remote control device or other input mechanism for access and output of user customizable content from a plurality of content sources;

FIG. 7 illustrates a representative content that provides a single hub at the console for establishes a marketplace of digital content that is important to the user and that can be displayed on a television;

FIGS. 8-11 illustrates a representative menu system that is user customizable; and

FIGS. 12-13 illustrate representative methods in accordance with embodiments of the present invention.

### DETAILED DESCRIPTION

The present invention relates to providing a single console to access and display or otherwise output user customizable content from a plurality of content sources. In particular, the present invention relates to channeling content from a variety of content sources to the television so as to provide a collection of all digital content that is important to the user and available on a single console, wherein the content may come from competing providers and is customizable by the user. Further, the system dynamically alerts and provides information to the user, wherein the alerts and information is customizable by the user.

In accordance with embodiments of the present invention, a single console is able to access a variety of content sources, thereby providing a single hub at the console for establishes a marketplace of digital content that is important to the user. Such sources include programming, digital music, digital pictures, games, communications, control systems, monitors, movies, and other types of digital content or functions. A menu is provided to allow a user to provide input to determine the preferred source for the programming, digital music, digital pictures, games, communications, control systems, monitors, movies, and other types of digital content. Thus, a collection of content providers is accessible by a single console/device. The collection of content providers is controllable by the user to provide the content sources and content that is desired by the user. The user determines the collection or array of content providers, which can include competing content providers and/or content providers that use different platforms. The various sources are masked or otherwise categorized through a single menu system to assist the user to navigate to the particular type of content that is desired, such as games, programming, music, monitoring systems, etc. The collection of all digital content that is important to the user converges and is made available at a single console. In some implementations, content sources are physical (i.e. home automation) to allow a user to monitor or otherwise control a function.

A universal resource manager is provided to selectively switch between the content on demand and to optimize the user environment. A collection of content types is provided and controllable by the user, such types include games, television, movies, music, computer format, etc. The user is able to select and/or associate one or more sources for each content type. Further, a user can create new content types and associate one or more content providers with the new content types. Each content type is a resource. The universal resource manager allows the user to virtually plug in a desired resource when wanted and unplug the resource when no longer wanted. Thus, for example, the universal resource manager allows a user to select the resource “games” and then the video games from the established game content source are available for play by for the user. Moreover, the experience is optimized by the universal resource manager by unplugging or otherwise not engaging any of the other content types to allow for optimal use of processing power and system settings for the desired resource, namely the video games. Once the user no longer desires to play the video games, the universal resource manager allows the user to virtually unplug the games resource on demand and virtually plug in another resource, such as “movies,” to allow the user to select a movie available from the movie content source/provider and thus watch the movie. The universal resource manager causes all processing power and settings to be optimized and available for the resource in use by virtually unplugging or otherwise disengaging all other resources.

In some embodiments, the user can virtually plug in multiple resources at the same time. For example, the user can listen to music from the music resource while at the same time surfing on the internet through the computer resource. However, when the computer resource is no longer desired and the user wants to experience a different resource, the browser is virtually unplugged such that it is completely turned off and is not consuming processing power to allow the processing power and settings to be used for the new resource that is desired by the user. Further, the user can virtually unplug the music resource or keep it playing while experiencing the new resource.

Thus, in accordance with at least some embodiments, the universal resource manager selectively launches or otherwise makes available content that is desired by the user and turns it off on demand, wherein the available content to the user comes from a variety of sources and across a variety of platforms.

While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

Embodiments of the present invention provide a console or platform that may be employed in association with all types of enterprises. The console or platform allows for a plethora of modifications that may be made with minimal impact to the processing unit, thereby enhancing the usefulness of the platform across all type of applications.

FIG. 1 and the corresponding discussion are intended to provide a general description of a suitable operating environment in accordance with embodiments of the present invention. As will be further discussed below, some embodiments embrace the use of one or more consoles, which are illustrated as modular processing units, in a variety of customizable enterprise configurations, including in a networked or combination configuration, as will be discussed below.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by one or more processors, such as one associated with a general-purpose modular processing unit capable of performing various different functions or one associated with a special-purpose modular processing unit capable of performing a limited number of functions.

Computer executable instructions cause the one or more processors of the enterprise to perform a particular function or group of functions and are examples of program code means for implementing steps for methods of processing. Furthermore, a particular sequence of the executable instructions provides an example of corresponding acts that may be used to implement such steps.

With reference to FIG. 1, a representative enterprise includes a console illustrated as modular processing unit 10, which may be used as a general-purpose or special-purpose processing unit. For example, modular processing unit 10 may be employed alone or with one or more similar modular processing units. Using multiple processing units in the same enterprise provides increased processing capabilities. For example, each processing unit of an enterprise can be dedicated to a particular task or can jointly participate in distributed processing.

In FIG. 1, modular processing unit 10 includes one or more buses and/or interconnect(s) 12, which may be configured to connect various components thereof and enables data to be exchanged between two or more components. Bus(es)/interconnect(s) 12 may include one of a variety of bus structures including a memory bus, a peripheral bus, or a local bus that uses any of a variety of bus architectures. Typical components connected by bus(es)/interconnect(s) 12 include one or more processors 14 and one or more memories 16. Other components may be selectively connected to bus(es)/interconnect(s) 12 through the use of logic, one or more systems, one or more subsystems and/or one or more I/O interfaces, hereafter referred to as “data manipulating system(s) 18.” Moreover, other components may be externally connected to bus(es)/interconnect(s) 12 through the use of logic, one or more systems, one or more subsystems and/or one or more I/O interfaces, and/or may function as logic, one or more systems, one or more subsystems and/or one or more I/O interfaces, such as modular processing unit(s) 30 and/or proprietary device(s) 34. Examples of I/O interfaces include one or more mass storage device interfaces, one or more input interfaces, one or more output interfaces, and the like. Accordingly, embodiments of the present invention embrace the ability to use one or more I/O interfaces and/or the ability to change the usability of a product based on the logic or other data manipulating system employed.

The logic may be tied to an interface, part of a system, subsystem and/or used to perform a specific task. Accordingly, the logic or other data manipulating system may allow, for example, for IEEE1394 (firewire), wherein the logic or other data manipulating system is an I/O interface. Alternatively or additionally, logic or another data manipulating system may be used that allows a modular processing unit to be tied into another external system or subsystem. For example, an external system or subsystem that may or may not include a special I/O connection. Alternatively or additionally, logic or other data manipulating system may be used wherein no external I/O is associated with the logic. Embodiments of the present invention also embrace the use of specialty logic, such as for ECUs for vehicles, hydraulic control systems, etc. and/or logic that informs a processor how to control a specific piece of hardware. Moreover, those skilled in the art will appreciate that embodiments of the present invention embrace a plethora of different systems and/or configurations that utilize logic, systems, subsystems and/or I/O interfaces.

As provided above, embodiments of the present invention embrace the ability to use one or more I/O interfaces and/or the ability to change the usability of a product based on the logic or other data manipulating system employed. For example, where a modular processing unit includes one or more I/O interfaces and logic, the logic or other data manipulating system may be changed to include flash memory or logic to perform audio encoding for a music station that wants to take analog audio via two standard RCAs and broadcast them to an IP address. Accordingly, the modular processing unit may be part of a system that is used as an appliance rather than a computer system due to a modification made to the data manipulating system(s) (e.g., logic, system, subsystem, I/O interface(s), etc.) on the back plane of the modular processing unit. Thus, a modification of the data manipulating system(s) on the back plane can change the application of the modular processing unit. Accordingly, embodiments of the present invention embrace very adaptable modular processing units.

As provided above, processing unit 10 includes one or more processors 14, such as a central processor and optionally one or more other processors designed to perform a particular function or task. It is typically processor 14 that executes the instructions provided on computer readable media, such as on memory(ies) 16, a magnetic hard disk, a removable magnetic disk, a magnetic cassette, an optical disk, or from a communication connection, which may also be viewed as a computer readable medium.

Memory(ies) 16 includes one or more computer readable media that may be configured to include or includes thereon data or instructions for manipulating data, and may be accessed by processor(s) 14 through bus(es)/interconnect(s) 12. Memory(ies) 16 may include, for example, ROM(s) 20, used to permanently store information, and/or RAM(s) 22, used to temporarily store information. ROM(s) 20 may include a basic input/output system (“BIOS”) having one or more routines that are used to establish communication, such as during start-up of modular processing unit 10. During operation, RAM(s) 22 may include one or more program modules, such as one or more operating systems, application programs, and/or program data.

As illustrated, at least some embodiments of the present invention embrace a non-peripheral encasement, which provides a more robust processing unit that enables use of the unit in a variety of different applications. In FIG. 1, one or more mass storage device interfaces (illustrated as data manipulating system(s) 18) may be used to connect one or more mass storage devices 24 to bus(es)/interconnect(s) 12. The mass storage devices 24 are peripheral to modular processing unit 10 and allow modular processing unit 10 to retain large amounts of data. Examples of mass storage devices include hard disk drives, magnetic disk drives, tape drives and optical disk drives.

A mass storage device 24 may read from and/or write to a magnetic hard disk, a removable magnetic disk, a magnetic cassette, an optical disk, a solid state storage device (such as a flash memory storage device) or another computer readable medium. Mass storage devices 24 and their corresponding computer readable media provide nonvolatile storage of data and/or executable instructions that may include one or more program modules, such as an operating system, one or more application programs, other program modules, or program data. Such executable instructions are examples of program code means for implementing steps for methods disclosed herein.

Data manipulating system(s) 18 may be employed to enable data and/or instructions to be exchanged with modular processing unit 10 through one or more corresponding peripheral I/O devices 26. Examples of peripheral I/O devices 26 include input devices such as a keyboard and/or alternate input devices, such as a mouse, remote input device, trackball, light pen, stylus, or other pointing device, a microphone, a joystick, a game pad, a satellite dish, a scanner, a camcorder, a digital camera, a sensor, and the like, and/or output devices such as a monitor or display screen, a televisions, a speaker, a printer, a control system, and the like. Similarly, examples of data manipulating system(s) 18 coupled with specialized logic that may be used to connect the peripheral I/O devices 26 to bus(es)/interconnect(s) 12 include a serial port, a parallel port, a game port, a universal serial bus (“USB”), a firewire (IEEE 1394), a wireless receiver, a video adapter, an audio adapter, a parallel port, a wireless transmitter, any parallel or serialized I/O peripherals or another interface.

Data manipulating system(s) 18 enable an exchange of information across one or more network interfaces 28. Examples of network interfaces 28 include a connection that enables information to be exchanged between processing units, a network adapter for connection to a local area network (“LAN”) or a modem, a wireless link, or another adapter for connection to a wide area network (“WAN”), such as the Internet. Network interface 28 may be incorporated with or peripheral to modular processing unit 10, and may be associated with a LAN, a wireless network, a WAN and/or any connection between processing units.

Data manipulating system(s) 18 enable modular processing unit 10 to exchange information with one or more other local or remote modular processing units 30 or computer devices. A connection between modular processing unit 10 and modular processing unit 30 may include hardwired and/or wireless links. Accordingly, embodiments of the present invention embrace direct bus-to-bus connections. This enables the creation of a large bus system. It also eliminates hacking as currently known due to direct bus-to-bus connections of an enterprise. Furthermore, data manipulating system(s) 18 enable modular processing unit 10 to exchange information with one or more proprietary I/O connections 32 and/or one or more proprietary devices 34.

Program modules or portions thereof that are accessible to the processing unit may be stored in a remote memory storage device. Furthermore, in a networked system or combined configuration, modular processing unit 10 may participate in a distributed computing environment where functions or tasks are performed by a plurality of processing units. Alternatively, each processing unit of a combined configuration/enterprise may be dedicated to a particular task. Thus, for example, one processing unit of an enterprise may be dedicated to video data, thereby replacing a traditional video card, and provides increased processing capabilities for performing such tasks over traditional techniques.

While those skilled in the art will appreciate that embodiments of the present invention may comprise a variety of configurations, reference is made to FIG. 2, which illustrates a representative embodiment of a durable and dynamically modular processing unit. In the illustrated embodiment of FIG. 2, processing unit 40 is durable and dynamically modular. In the illustrated embodiment, unit 40 is approximately a 3½-inch (8.9 cm) cube platform that utilizes an advanced thermodynamic cooling model, eliminating any need for a cooling fan.

However, as provided herein, embodiments of the present invention embrace the use of other cooling processes in addition to or in place of a thermodynamic cooling process, such as a forced air cooling process and/or a liquid cooling process. Moreover, while the illustrated embodiment includes a 3½-inch cube platform, those skilled in the art will appreciate that embodiments of the present invention embrace the use of a modular processing unit that is greater than or less than a 3½-inch cube platform. Similarly, other embodiments embrace the use of shapes other than a cube.

Processing unit 40 also includes a layered motherboard configuration, that optimizes processing and memory ratios, and a bus architecture that enhances performance and increases both hardware and software stability, each of which will be further discussed below. Those skilled in the art will appreciate that other embodiments of the present invention also embrace non-layered motherboards. Moreover, other embodiments of the present invention embrace embedded motherboard configurations, wherein components of the motherboard are embedded into one or more materials that provide an insulation between components and embed the components into the one or more materials, and wherein one or more of the motherboard components are mechanical, optical, electrical or electro-mechanical. Furthermore, at least some of the embodiments of embedded motherboard configurations include mechanical, optical, electrical and/or electro-mechanical components that are fixed into a three-dimensional, sterile environment. Examples of such materials include polymers, rubbers, epoxies, and/or any non-conducting embedding compound(s).

Embodiments of the present invention embrace providing processing versatility. For example, in accordance with at least some embodiments of the present invention, processing burdens are identified and then solved by selectively dedicating and/or allocating processing power. For example, a particular system is defined according to specific needs, such that dedication or allocation of processing power is controlled. Thus, one or more modular processing units may be dedicated to provide processing power to such specific needs (e.g., video, audio, one or more systems, one or more subsystems, etc.). In some embodiments, being able to provide processing power decreases the load on a central unit. Accordingly, processing power is driven to the areas needed.

While the illustrated embodiment, processing unit 40 includes a 3 GHz processor and 2 GB of RAM, those skilled in the art will appreciate that other embodiments of the present invention embrace the use of a faster or slower processor and/or more or less RAM. In at least some embodiments of the present invention, the speed of the processor and the amount of RAM of a processing unit depends on the nature for which the processing unit is to be used.

A highly dynamic, customizable, and interchangeable back plane 44 provides support to peripherals and vertical applications. In the illustrated embodiment, back plane 44 is selectively coupled to encasement 42 and may include one or more features, interfaces, capabilities, logic and/or components that allow unit 40 to be dynamically customizable. In the illustrated embodiment, back plane 44 includes DVI Video port 46, Ethernet port 48, USB ports 50 (50a and 50b), SATA bus ports 52 (52a and 52b), power button 54, and power port 56. Back plane 44 may also include a mechanism that electrically couples two or more modular processing units together to increase the processing capabilities of the entire system as indicated above, and to provide scaled processing as will be further disclosed below.

Those skilled in the art will appreciate that back plane 44 with its corresponding features, interfaces, capabilities, logic and/or components are representative only and that embodiments of the present invention embrace back planes having a variety of different features, interfaces, capabilities and/or components. Accordingly, a processing unit is dynamically customizable by allowing one back plane to be replaced by another back plane in order to allow a user to selectively modify the logic, features and/or capabilities of the processing unit.

Moreover, embodiments of the present invention embrace any number and/or type of logic and/or connectors to allow use of one or more modular processing units 40 in a variety of different environments. For example, the environments include vehicles (e.g., cars, trucks, motorcycles, etc.), hydraulic control systems, and other environments. The changing of data manipulating system(s) on the back plane allows for scaling vertically and/or horizontally for a variety of environments, as will be further discussed below.

Furthermore, embodiments of the present invention embrace a variety of shapes and sizes of modular processing units. For example, in FIG. 2 modular processing unit 40 is a cube that is smaller than traditional processing units for a variety of reasons.

As will be appreciated by those skilled in the art, embodiments of the present invention are easier to support than traditional techniques because of, for example, materials used, the size and/or shape, the type of logic and/or an elimination of a peripherals-based encasement.

In the illustrated embodiment, power button 54 includes three states, namely on, off and standby for power boot. When the power is turned on and received, unit 40 is instructed to load and boot an operating system supported in memory. When the power is turned off, processing control unit 40 will interrupt any ongoing processing and begin a shut down sequence that is followed by a standby state, wherein the system waits for the power on state to be activated.

USB ports 50 are configured to connect peripheral input/output devices to processing unit 40. Examples of such input or output devices include a keyboard, a mouse or trackball, a monitor, printer, another processing unit or computer device, a modem, and a camera.

SATA bus ports 52 are configured to electronically couple and support mass storage devices that are peripheral to processing unit 40. Examples of such mass storage devices include floppy disk drives, CD-ROM drives, hard drives, tape drives, and the like.

As provided above, other embodiments of the present invention embrace the use of additional ports and means for connecting peripheral devices, as will be appreciated by one of ordinary skill in the art. Therefore, the particular ports and means for connecting specifically identified and described herein are intended to be illustrative only and not limiting in any way.

As provided herein, a variety of advantages exist through the use of a non-peripheral processing unit over larger, peripheral packed computer units. By way of example, the user is able to selectively reduce the space required to accommodate the enterprise, and may still provide increased processing power by adding processing units to the system while still requiring less overall space. Moreover, since each of the processing units includes solid-state components rather than systems that are prone to breaking down, the individual units may be hidden (e.g., in a wall, in furniture, in a closet, in a decorative device such as a clock).

The durability of the individual processing units/cubes allows processing to take place in locations that were otherwise unthinkable with traditional techniques. For example, the processing units can be buried in the earth, located in water, buried in the sea, placed on the heads of drill bits that drive hundreds of feet into the earth, on unstable surfaces in furniture, etc. The potential processing locations are endless. Other advantages include a reduction in noise and heat, an ability to provide customizable “smart” technology into various devices available to consumers, such as furniture, fixtures, vehicles, structures, supports, appliances, equipment, personal items, etc.

With reference now to FIG. 3A, another view of the embodiment of FIG. 2 is provided, wherein the view illustrates processing unit 40 with the side walls of the cube removed to more fully illustrate the non-peripheral based encasement, cooling process (e.g., thermodynamic convection cooling, forced air, and/or liquid cooling), optimized layered circuit board configuration, and dynamic back plane. In the illustrated embodiment, the various boards are coupled together by using a force fit technique, which prevents accidental decoupling of the boards and enables interchangeability. The boards provide for an enhanced EMI distribution and/or chip/logic placement. Those skilled in the art will appreciate that embodiments of the present invention embrace any number of boards and/or configurations. Furthermore, board structures may be modified for a particular benefit and/or need based on one or more applications and/or features. In FIG. 3A, processing unit 40 includes a layered circuit board/motherboard configuration 60 that includes two parallel sideboards 62 (62a and 62b) and a central board 64 transverse to and electronically coupling sideboards 62. While the illustrated embodiment provides a tri-board configuration, those skilled in the art will appreciate that embodiments of the present invention embrace board configurations having less than three boards, and layered board configurations having more than three boards. Moreover, embodiments of the present invention embrace other configurations of circuit boards, other than boards being at right angles to each other.

In the illustrated embodiment, the layered motherboard 60 is supported within encasement 42 using means for coupling motherboard 60 to encasement 42. In the illustrated embodiment, the means for coupling motherboard 60 to encasement 42 include a variety of channeled slots that are configured to selectively receive at least a portion of motherboard 60 and to hold motherboard 60 in position. As upgrades are necessary with the advancing technology, such as when processor 66 is to be replaced with an improved processor, the corresponding board (e.g., central board 64) is removed from the encasement 42 and a new board with a new processor is inserted to enable the upgrade. Accordingly, embodiments of the present invention have proven to facilitate upgrades as necessary and to provide a customizable and dynamic processing unit.

Processing unit 40 also includes one or more processors that at are configured to perform one or more tasks. In FIG. 3A, the one or more processors are illustrated as processor 66, which is coupled to central board 64. As technology advances, there may be a time when the user of processing unit 40 will want to replace processor 66 with an upgraded processor. Accordingly, central board 64 may be removed from encasement 42 and a new central board having an upgraded processor may be installed and used in association with unit 40. Accordingly, embodiments of the present invention embrace dynamically customizable processing units that are easily upgraded and thus provide a platform having longevity in contrast to traditional techniques.

According to some embodiments a processor cooling system may be attached to the processor 66. A number of devices can be used to cool the processor including a heat sink, fan, combinations thereof, and various other devices known in the art.

Similarly, processing unit 40 can include one or more memory devices (not shown). Memory may be coupled to an electronic circuit board in various ways, including a memory card removably coupled to a slot on a circuit board or a memory card directly couple to the circuit board. In some embodiments of the present invention, an entire circuit board of a modular motherboard may be substantially dedicated to providing one or more memory devices. As technology advances, there may be a time when the user of processing unit 40 will want to replace a memory device with an upgraded memory device. Accordingly, the circuit board containing the memory device may be removed from encasement 42 and a new circuit board having an upgraded processor may be installed and used in association with unit 40.

The motherboard 60 of the present invention is modular and easily upgradeable. The modular motherboard 60 is comprised of a plurality of electronic circuit boards that makes an integrated logic board equal in ability and performance to that of a non-modular motherboard having the same components. The modular motherboard 60 is composed of several electronic circuit boards 64, 62a, and 62b, which interconnect to form a complete logic board, or motherboard. Thus, each electronic circuit board can be easily removed and replaced without substantially affecting the remaining circuit boards. For example, a user may replace a circuit board 64 having a processor 66 and replace it with another circuit board having a different processor to provide increasing processing power to the processing unit 40.

Each board includes a bus system which connects to the bus system of another circuit board. The bus system provides electronic communication between the interconnected circuit boards forming the modular motherboard 60. The modular motherboard can be comprised of any number of circuit boards. For example, in one embodiment, a motherboard includes four circuit boards, each having a particular function, such as processing, providing memory, providing storage, and providing BIOS. In another embodiment, a circuit board has more than one function, such as processing and memory capabilities. In another embodiment, a single function is performed by more than one circuit board. Additional functions performed by individual circuit boards include, but are not limited to, providing a clock generator, providing a cooling system, and other motherboard functions as understood by those of skill in the art.

The modular motherboard 60 provides a number of advantages over single-circuit-board motherboards. For example, when the modular motherboard 60 doesn't support a specific component, a user need only replace a single circuit board with a compatible circuit board rather than replacing the entire motherboard. Additionally, a modular motherboard is not constrained to a two-dimensional area like single-circuit-board motherboards. As such, the modular mother board 60 may be configured to fit within smaller, three-dimensional encasements. For example, where the modular motherboard includes four circuit boards, the boards can be configured to utilize one fourth the footprint area used by an equivalent single-circuit-board motherboard. Finally, a modular motherboard 60 is easily scalable. For example, a user may easily attach an additional circuit board (not shown) to the preexisting motherboard configuration to scale the processing power of the whole structure. One of skill in the art will appreciate that the modular motherboard 60 provides an unlimited number of advantages when used in conjunction with specific applications and computer systems.

According to some embodiments of the processing unit of the present invention one or more electronic storage devices are included with the modular motherboard. The addition of electronic storage, such as a mass storage device, has the ability to enhance the processing and computing abilities of the processing unit. For example, a processing unit with electronic storage capacity can be used as a personal computer by merely attaching the essential peripheral devices, such as a monitor, mouse, and keyboard. Also a processing unit with electronic storage capacity can be effective and useful as an engine that drives and controls the operation of a component, structure, assembly, equipment module, as shown in FIGS. 14-16. For example a processing unit may store a digital log of the functions or performance of equipment in electronic storage. In another example, a processing unit may control both a stereo system and store a user's digital music library.

Referring now to FIG. 3B, another embodiment of the present invention is provided, wherein the view illustrates processing unit 160 with the side walls of the cube removed to more fully illustrate the non-peripheral based encasement, a plurality of layered circuit boards, and dynamic backplane 44. The layered circuit boards include two parallel sideboards 162 (162a and 162b) and a central board 164 transverse to and electronically coupling sideboards 162a and 162b.

In the embodiment of FIG. 3B, the central board 164 includes a processor 66 and memory devices 150a, 150b, and 150c, and sideboard 162b includes a plurality of electronic storage devices 166a, 166b, and 166c. As described above, the motherboard 168 is easily upgraded by removing a sideboard 162 or the central board 164 and replacing them with another circuit board. In another embodiment, boards are replaced with upgraded boards with improved abilities. A user interchanges one or more circuit boards 162a, 162b, or 164 to decrease the processing power, available memory, storage capacity, or other properties of the processing unit 160. Such upgrades or downgrades are possible and easily accomplished with the modular motherboard.

Various types of electronic storage devices can be utilized with the present processing unit 160. For example, solid state memory, such as flash memory, provides a number of benefits to modular processing units. Solid state memory uses low levels of power, which result in low levels of heat dissipations. As such, it is possible for one or more such solid state storage devices to be included in a relatively small processing unit 160 without substantially increasing the heat dissipated by the unit. For example, in one particular embodiment a sideboard 162b includes a plurality of flash memory storage devices 166a, 166b, and 166c that together provide 128 Gb of data storage. As configured, these storage devices uses less than five watts of energy, which will create minimal heat that is easily dissipate into the environment through natural convection, or another cooling method.

With reference now to FIG. 3C, another embodiment of the present invention is provided, wherein the view illustrates processing unit 140. Processing unit 140 includes an encasement, a modular motherboard 148, and a dynamic backplane 144. In this embodiment the modular motherboard 148 includes three parallel sideboards 62a, 62b, and 62c and a central board 142 transverse to and electronically coupling sideboards 62. Unlike the three-board configuration of FIGS. 3 and 4, the four-board configuration includes a third parallel sideboard 62c. The third parallel sideboard is configured beneath and parallel to sideboard 62b. One of skill in the art will appreciate that the four circuit boards may be configured in a variety of orientations. In some embodiment, a four-board configuration may be configured to positioning hot components strategically for maximum heat dissipation.

According to one embodiment encasement 42 is elongated to accommodate fourth sideboard 62c. In another embodiment, central board 142 is elongated to accommodate fourth sideboard 62c. In yet another embodiment, sideboard 62b is repositioned along central board 142 and sideboard 62c is positioned below it to accommodate fourth sideboard 62c. In yet another embodiment, the encasement can be elongated to accommodate fourth sideboard 62c.

The increased number of circuit boards in the four-board configuration provides additional surface area on the modular motherboard 148 for computer components. In one embodiment, the additional surface area provided by the four-board configuration is used for additional components, such as additional memory devices or an additional processor. As previously explained, storage devices utilize relatively low levels of energy and thus dissipate relatively low levels of heat. Thus, in some embodiments, a storage device is stored in relative proximity to other computer components without producing damaging heat or requiring a designated cooling device.

In one embodiment, one or more of the circuit boards in the four-board configuration includes a storage device 65 that provide electronic storage capabilities to the processing unit 140. In another embodiment, the storage device 65 is a solid state storage device, such as a flash memory device or another similar storage device. In another embodiment, an entire sideboard 62c is substantially dedicated to electronic storage, such as one or more flash memory device(s). Due to the relatively low levels of heat dissipated from the solid state storage devices the gap 150 between sideboard 62c and sideboard 62b is narrow and compact. Thus, the relative size of a processing unit 140 is relatively similar or equal to the size of a processing unit that doesn't include an electronic storage device.

The storage device 65 or plurality of storage devices may provide the processing unit 140 with sufficient electronic storage for it to perform one or more designated functions. According to one embodiment, the one or more storage device(s) may provide sufficient electronic storage to use the processing unit 140 as a personal computer. For example, a plurality of storage devices 65 are includes on sideboard 62c which may provide the processing unit between 16 Gb and 256 Gb of electronic storage. In another embodiment, the storage device 65 provides only 256 Mb of electronic storage, and the processing unit 140 is utilized to control the functions of home appliance.

In the illustrated embodiment, the dynamic backplane 144 includes a single port 146. It will be understood that any number of ports, buttons, switches, or other like components may be included in the dynamic backplane 144. For example, in one embodiment the dynamic backplane can have wireless communication capabilities. In another embodiment, the dynamic backplane 144 includes only a single port which may be configured to connect to a number of external devices. In one embodiment, the single port 146 is configured to connect to a power supply, a personal computer, a computer server, a docking station, or other external device as will be understood by one of skill in the art. Finally, in one embodiment, single port 146 is a proprietary port that connects to a proprietary docking station.

FIG. 4 and the corresponding discussion are intended to provide a general description of a suitable operating environment in which embodiments of the invention may be implemented, taken in conjunction with the disclosure of the related applications incorporated herein by reference. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 4, a representative system for implementing embodiments of the invention includes a console, illustrated as computer device 210, which may be a general-purpose or special-purpose computer or any of a variety of consumer electronic devices. For example, computer device 210 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, a modular computer as disclosed in the related applications or the like.

Computer device 210 includes system bus 212, which may be configured to connect various components thereof and enables data to be exchanged between two or more components. System bus 212 may include one of a variety of bus structures including a memory bus or memory controller, a peripheral bus, or a local bus that uses any of a variety of bus architectures. Typical components connected by system bus 212 include processing system 214 and memories 216. Other components may include one or more mass storage device interfaces 218, input interfaces 220, output interfaces 222, and/or network interfaces 224, each of which will be discussed below.

Processing system 214 includes one or more processors, such as a central processor and optionally one or more other processors designed to perform a particular function or task. It is typically processing system 214 that executes the instructions provided on computer-readable media, such as on memories 216, a magnetic hard disk, a removable magnetic disk, a magnetic cassette, an optical disk, or from a communication connection, which may also be viewed as a computer-readable medium.

Memories 216 includes one or more computer-readable media that may be configured to include or includes thereon data or instructions for manipulating data, and may be accessed by processing system 214 through system bus 212. Memories 216 may include, for example, ROM 228, used to permanently store information, RAM 230, used to temporarily store information, and/or hybrid memories 231. ROM 228 may include a basic input/output system (“BIOS”) having one or more routines that are used to establish communication, such as during start-up of computer device 210. RAM 230 may include one or more program modules, such as one or more operating systems, application programs, and/or program data. Hybrid memories 231 may have features and capabilities hybridized from those of ROM 228 and RAM 230.

One or more mass storage device interfaces 218 may be used to connect one or more mass storage devices 226 to system bus 212. The mass storage devices 226 may be incorporated into or may be peripheral to computer device 210 and allow computer device 210 to retain large amounts of data. Optionally, one or more of the mass storage devices 226 may be removable from computer device 210. Examples of mass storage devices include hard disk drives, magnetic disk drives, tape drives, solid state drives/flash drives, hybrid drives utilizing multiple storage types, and optical disk drives. A mass storage device 226 may read from and/or write to a magnetic hard disk, a removable magnetic disk, a magnetic cassette, an optical disk, or another computer-readable medium. Mass storage devices 226 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 220 may be employed to enable a user to enter data and/or instructions to computer device 210 through one or more corresponding input devices 232. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 220 that may be used to connect the input devices 232 to the system bus 212 include a serial port, a parallel port, a game port, a universal serial bus (“USB”), an integrated circuit, a firewire (IEEE 1394), or another interface. For example, in some embodiments input interface 220 includes an application specific integrated circuit (ASIC) that is designed for a particular application. In a further embodiment, the ASIC is embedded and connects existing circuit building blocks.

One or more output interfaces 222 may be employed to connect one or more corresponding output devices 234 to system bus 212. Examples of output devices include a monitor or display screen, a speaker, a printer, a multi-functional peripheral, and the like. A particular output device 234 may be integrated with or peripheral to computer device 210. Examples of output interfaces include a video adapter, an audio adapter, a parallel port, and the like.

One or more hybrid media interfaces 223 may be employed to connect one or more hybrid media devices 235 to the system bus 212. A hybrid media interface 223 may include multiple single input/output ports and/or buses combined on a single connector to provide added value. Non-limiting examples of the types of ports/buses that can be combined in the hybrid media interface(s) 223 and/or associated buses/ports include PCIe, I²C, power, a proprietary secure bus, SATA, USB, and the like. The hybrid media devices 235 so connected to the computer device 210 may include a variety of peripheral devices, storage systems, PCIe devices, USB devices, SATA devices and the like.

One or more network interfaces 224 enable computer device 210 to exchange information with one or more other local or remote computer devices, illustrated as computer devices 236, via a network 238 that may include hardwired and/or wireless links. Examples of network interfaces include a network adapter for connection to a local area network (“LAN”) or a modem, wireless link, or other adapter for connection to a wide area network (“WAN”), such as the Internet. The network interface 224 may be incorporated with or peripheral to computer device 210. In a networked system, accessible program modules or portions thereof may be stored in a remote memory storage device. Furthermore, in a networked system computer device 210 may participate in a distributed computing environment, where functions or tasks are performed by a plurality of networked computer devices.

Thus, while those skilled in the art will appreciate that embodiments of the present invention may be practiced in a variety of different environments with many types of system configurations, FIG. 5 provides a representative networked system configuration that may be used in association with embodiments of the present invention. The representative system of FIG. 5 includes a console, illustrated as client 240, which is connected to one or more other consoles (illustrated as clients 242) and one or more peripheral devices 246, such as a television or other output device or system, across a network 238 or other connection.

While FIG. 5 illustrates an embodiment that includes a client 240, two additional clients 242, peripheral device 246, and optionally a server 248 connected to network 238, alternative embodiments include more or fewer clients, more than one peripheral device, no server, and/or more than one server connected to a network. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

As provided herein, embodiments of the present invention embrace providing a single console to access and display or otherwise output user customizable content from a plurality of content sources. In particular, the present invention relates to channeling content from a variety of content sources to the television so as to provide a collection of all digital content that is important to the user and available on a single console, wherein the content may come from competing providers and is customizable by the user. Further, the system dynamically alerts and provides information to the user, wherein the alerts and information is customizable by the user.

In accordance with embodiments of the present invention, a single console is able to access a variety of content sources, thereby providing a single hub at the console for establishing a marketplace of digital content that is important to the user. Such sources include programming, digital music, digital pictures, games, communications, control systems, monitors, movies, and other types of digital content or functions. A menu is provided to allow a user to provide input to determine the preferred source for the programming, digital music, digital pictures, games, communications, control systems, monitors, movies, and other types of digital content. Thus, a collection of content providers is accessible by a single console/device. The collection of content providers is controllable by the user to provide the content sources and content that is desired by the user. The user determines the collection or array of content providers, which can include competing content providers and/or content providers that use different platforms. The various sources are masked or otherwise categorized through a single menu system to assist the user to navigate to the particular type of content that is desired, such as games, programming, music, monitoring systems, etc. The collection of all digital content that is important to the user converges and is made available at a single console. In some implementations, content sources are physical (i.e. home automation) to allow a user to monitor or otherwise control a function.

FIG. 6 illustrates a representative console connected to a television and controlled by a remote control device or other input mechanism for access and output of user customizable content from a plurality of content sources. In FIG. 6, home entertainment and control system 250 includes television display 252 and console 254. The console 254 provides access to a collection of all digital content that is important to the user and is controllable through utilization of a dynamic menu system and selectively providing input, such as through input device 258. Console 254 provides a common platform to cross multiple outputs from multiple sources. In some embodiments, the system determines the sources base on established criteria, such as popularity. In other embodiments, the sources are determined by the user. For example, for programming the user is able to identify multiple content providers, such as cable, DirectTV, satellite TV, streaming programming, Hulu, or other services that all are received at the one single console for display of the programming at the television display. Thus, a single, universal set top box or console is used to provide programming content from a plethora of content sources. In some embodiments, the sources include physical sources, such as home automation. Thus, the console 254 can not only be used to display programming, but can also be used to accessing a monitoring system, perform a function (ie. control garage doors, lights, sprinklers, devices, appliances, baby monitors, etc.), and dynamically notify the user while watching programming or playing a game. Thus, the programming or game can be interrupted by a picture in picture, for example, of a monitoring system to inform the user that someone is at the front door to allow the user to unlock the front door and allow the person to enter the home.

Console 254 allows all digital content providers to be made available through a single source platform, market place, or virtual entertainment mall. The different types of content can be accessed through a dynamic menu 256.

FIG. 7 illustrates a representative content that provides a single hub at the console for establishes a marketplace of digital content that is important to the user and that can be displayed on a television. With reference to FIG. 7, console 254 can access any type of digital content through any type of content source 260. Examples of content sources include a location of where digital pictures are located, a location of where digital media is located, iTunes, satellite radio, Pandora, Amazon cloud,—cable television programming, Direct TV programming, satellite programming, streaming programming, streaming movies, a location where digital movies are stored, email, instant messaging, video messaging, home automation controls, streaming music, and any other source for digital content or information that could be desired by a user. Accordingly, rather than each content provider requiring their own set top box or platform, console 254 is a single platform/hub/market place/device that allows a user to access and display any desired content from any one or more content sources 260 on an output device, such as television 252. Other output systems could include a stereo system, a surround system used in home entertainment system, and any other output device.

In at least some embodiments, the console includes a universal resource manager that allows the user to selectively switch between the content on demand and to optimize the user environment. A collection of content types is provided and controllable by the user, such types include games, television, movies, music, computer format, etc. The user is able to select and/or associate one or more sources for each content type. Further, a user can create new content types and associate one or more content providers with the new content types. Each content type is a resource. The universal resource manager allows the user to virtually plug in a desired resource when wanted and unplug the resource when no longer wanted. Thus, for example, the universal resource manager allows a user to select the resource “games” and then the video games from the established game content source are available for play by for the user. Moreover, the experience is optimized by the universal resource manager by unplugging or otherwise not engaging any of the other content types to allow for optimal use of processing power and system settings for the desired resource, namely the video games. Once the user no longer desires to play the video games, the universal resource manager allows the user to virtually unplug the games resource on demand and virtually plug in another resource, such as “movies,” to allow the user to select a movie available from the movie content source/provider and thus watch the movie. The universal resource manager causes all processing power and settings to be optimized and available for the resource in use by virtually unplugging or otherwise disengaging all other resources.

In some embodiments, the user can virtually plug in multiple resources at the same time. For example, the user can listen to music from the music resource while at the same time surfing on the internet through the computer resource. However, when the computer resource is no longer desired and the user wants to experience a different resource, the browser is virtually unplugged such that it is completely turned off and is not consuming processing power to allow the processing power and settings to be used for the new resource that is desired by the user. Further, the user can virtually unplug the music resource or keep it playing while experiencing the new resource.

Thus, in accordance with at least some embodiments, the universal resource manager selectively launches or otherwise makes available content that is desired by the user and turns it off on demand, wherein the available content to the user comes from a variety of sources and across a variety of platforms.

In at least some embodiments, the uniform resource manager of console 254 includes an optimization package that allows for the system to push or otherwise establish settings that are optimal for the particular resource that is desired and is launched, virtually switched on, or virtually plugged in. The optimized settings are determined and used. The processing resources that are not seen or are not needed are not used. They are effectively eliminated. Therefore, only the processing resources that are needed are used. This allows for optimal utilization of processing resources. In further embodiments, the optimization is to the specific game play at the time. Thus, the system is able to dynamically turn on or off settings and/or processing resources based on what is needed in that instance in time. In some embodiments, the dynamically turning on or off of settings and/or processing resources is performed automatically by the system or is performed on demand by user calls. In some embodiments, optimized settings are pushed to consoles or otherwise obtained for particular content resources.

In some embodiments, the console is run in appliance mode. In some embodiments, calls are used to inform the console to run in appliance mode. In some embodiments, the application is limited to manage or otherwise control the user environment and experience.

In some embodiments, the uniform resource manager allows the console to provide a single environment that the user interacts with and then it is closed down. Another environment can then be interacted with and then closed down. In some embodiments, multiple environments can be interacted with simultaneously and then one or more (even all) of the environments can be closed down.

In some embodiments, the user can establish the resource name, resource and/or resource source as desired.

Further, in at least some embodiments, the universal resource manager allows for the use of the desired resource on a monitor, a television, a phone or other electronic device.

FIGS. 8-11 illustrates a representative dynamic menu system that is customizable by the user. In FIG. 8, a representative listing of categories is provided for which content may be played and/or functions may be performed. In FIG. 9, a user input device or sensor is used to select any of the categories. In FIG. 10, the categories can be colored or highlighted as desired by the use. In FIG. 11, the user can identify the desired content source(s) for each of the categories. Thus, as illustrated in FIG. 11, the user can identify the type of gaming by listing the gaming sources as Steam, Hawken, Origins, etc. In some embodiments, the available sources are established by the system. In further embodiments, the system provides the available sources based upon popularity of use by the user. In some embodiments, the available sources are selectable by a user, and can include a source (ie. a game) that is saved locally at the console or that is accessed remotely from a storage device. In some embodiments, the user establishes the content sources for which each category pertains.

Thus in some embodiments, a collection of content providers is made available through a single console, box or device. The single console channels content providers to media system that is customizable and controllable by the user. In at least some embodiments, the user determines the collection or array of content providers and/or content sources and receives such through a single console. Libraries of content may be located in a variety of sources and though a variety of providers, but can be accessed through a single console, thus converging the accessibility of content at a single console. The user determines the source of the particular content. In some embodiments, the menu is customizable. In some embodiments, the location of content is customizable. In some embodiments, content may be stored locally and transported by the user to other locations for display or use. In some embodiments, the console is able to access software to perform a function. For example, a user can play media, control cameras around a house, control appliances, turn on sprinklers, turn on/off lights, monitor a baby, be alerted to when a baby awakes, be alerted to when someone is at the front door, can do things across platforms, etc.

As provided herein, embodiments of the present invention relate to providing a single console to access and display or otherwise output user customizable content from a plurality of content sources. In particular, the present invention relates to channeling content from a variety of content sources, including competing sources on one or more platforms, to the television and/or other output device so as to provide a collection of all digital content that is important to the user and available on a single console, wherein the content is customizable by the user. Further, the system dynamically alerts and provides information to the user, wherein the alerts and information is customizable by the user.

As further provided herein, in accordance with embodiments of the present invention, a single console is able to access a variety of content sources, thereby providing a single hub at the console for establishes a marketplace of digital content that is important to the user. Such sources include programming, digital music, digital pictures, games, communications, control systems, monitors, movies, and other types of digital content or functions. A menu is provided to allow a user to provide input to determine the preferred source for the programming, digital music, digital pictures, games, communications, control systems, monitors, movies, and other types of digital content.

Thus, a collection of content providers is accessible by a single console/device. The collection of content providers is controllable by the user to provide the content sources and content that is desired by the user. The user determines the collection or array of content providers, which can include competing content providers and/or content providers that use different platforms. The various sources are masked or otherwise categorized through a single menu system to assist the user to navigate to the particular type of content that is desired, such as games, programming, music, monitoring systems, etc. The collection of all digital content that is important to the user converges and is made available at a single console. In some implementations, content sources are physical (i.e. home automation) to allow a user to monitor or otherwise control a function.

FIGS. 12-13 illustrate representative methods in accordance with embodiments of the present invention.

The present invention may be embodied in other specific forms without departing from its spirit or essential characteristics. The described embodiments and examples are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A digital media console system comprising:
a console that can selectively access content from a variety of content sources across any of a variety of platforms, wherein the content sources are selectable by a user; and
an output device communicatively connected to the console to output the content that is selectable by the user.
